(19) United States
(12) Patent Application Publication
(10) Pub. No.: US 2009/0293332 A1
(43) Pub. Date: Dec. 3, 2009

(54) FLIP UP CARDHOLDER FOR ANIMAL CAGES

(76) Inventors: Richard P. Ver Hage, Midland Park, NJ (US); Glenn R. Ver Hage, Midland Park, NJ (US); Henry W. Ver Hage, Midland Park, NJ (US)

Correspondence Address: SOFER & HAROUN LLP., 317 MADISON AVENUE, SUITE 910, NEW YORK, NY, 10017, US

(21) Appl. No.: 12/472,547

(22) Filed: May 27, 2009

Related U.S. Application Data
(63) Continuation of application No. 61/130,184, filed on May 28, 2008.

(51) Int. Cl. G09F 3/18

(52) U.S. Cl. 40/642.02

(57) ABSTRACT

A card holder, for use on an animal cage, includes a card receiving area and a cam area for connecting the card holder to a pivot bar on the animal cage. The cam area includes, a hook, a pin clearance, a lead and a holding notch so that the card holder may be raised from a lower hanging position to an upward locked position.

### RELATED APPLICATION

This application claims the benefit of priority from U.S. Provisional Patent Application No. 61/130,184, filed on May 28, 2008, the entirety of which is incorporated by reference.

### BACKGROUND

1. Field of the Invention

This invention relates to devices and methods for identifying individual animal cages and in particular to cardholders affixed to the animal cages.

2. Description of Related Art

Animal cages are used for housing small animals such as mice, rats and guinea pigs for research purposes. To keep the identification of these animals and testing orderly and accurate, there are cardholders affixed to the cage that these animals are housed in. The cardholders usually hold an index type card with pertinent information typed or written on them to identify procedures, types of animals and other data that is needed for the research projects.

Cardholders have been made for many years. Because the cages must be cleaned and sterilized, most of that time the card holders were made out of stainless steel, punched out of sheet metal. When used, they would usually hang from the top edge of the cage bottom. As an example, an integral U-shaped hook on the cardholder would wrap over the top edge.

More recently, there have been improvements made to animal cage cardholders, such as making them out of plastic, possibly with the ability to flip up.

### OBJECTS AND SUMMARY

The present application is an improved cardholder for use with animal cages that is a plastic cardholder that can be used as a hanging cardholder or as a flip-up cardholder. The flip-up cardholder can be moved from its normal hanging position and be rotated up 90 degrees and lock into that position. By rotating and locking it at the 90 degree position, it allows the laboratory technician to look behind the card into the cage to see what is happening inside more clearly; to check on the animals; to check on the watering and condition of the food and bedding and observe test procedures that are taking place.

Moreover, the locked animal cage flip up cardholder allows for an easier surface to mark the cages and an easier manner to read the cards therein on cages located on lower racks of a rack storage unit.

Furthermore, when many animal cages are placed along side one another in a typical rack storage unit, the ability of the cardholders to flip-up and lock into a horizontal position, allows them to be used as an easy marking system, when certain actions are being taken on some or all of the cages in the rack storage unit (ie. the administration of a treatment etc. . . . ), letting the technician know when they are finished with a particular cage.

To this end, a card holder, for use on an animal cage, includes a card receiving area and a cam area for connecting the card holder to a pivot bar on the animal cage. The cam area includes, a hook, a pin clearance, a lead and a holding notch so that the card holder may be raised from a lower hanging position to an upward locked position.

### BRIEF DESCRIPTION OF THE DRAWING

The present invention can be best understood through the following description and accompanying drawings, wherein:

FIG. 1 illustrates a perspective view of an animal cage with a cardholder, according to one embodiment;

FIG. 2 illustrates a perspective view of an animal cage with a cardholders according to another embodiment;

FIG. 3 is a separate element that may be attached to an animal cage to provide a flip-up cardholder, in accordance with another embodiment.

FIG. 4 illustrates a perspective view of an animal cage with a cardholder as shown in FIG. 1, with the cardholder in the down position, according to one embodiment

FIG. 5 is a side view of an animal cage with a cardholder as shown in FIG. 4, with the cardholder in the non-locked up position, according to one embodiment;

FIG. 6 is a side view of an animal cage with a cardholder as shown in FIG. 4, with the cardholder in the locked up position, according to one embodiment;

FIG. 7 is a perspective side view of an animal cage with a cardholder in the up position, according to one embodiment; and

FIGS. 8A-8C are a progression showing an animal cage of FIG. 5 with the cardholder moving from the locked up position to the un-locked up position.

### DETAILED DESCRIPTION

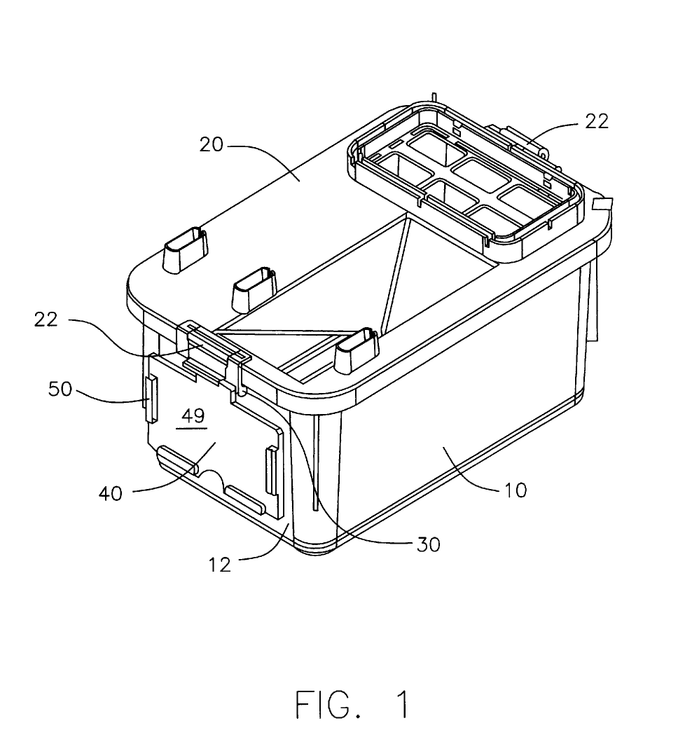

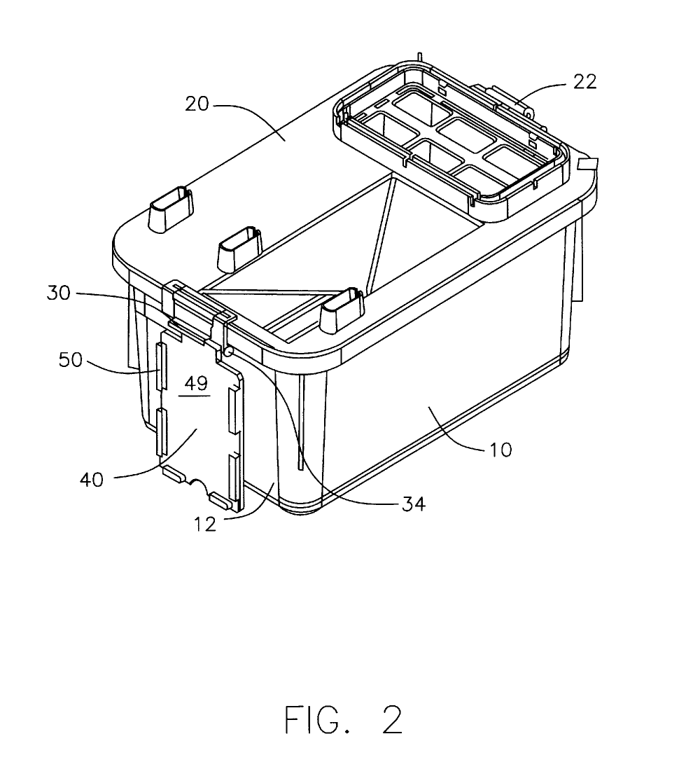

In one arrangement, as shown in FIGS. 1 and 2, an animal cage 10 is provided with a top 20, such as a micro filter top. Top 20 may be clipped or sealed onto cage 10 via clipping units 22.

A mounting structure 30 is located on the front face 12 of cage 10 and configured to hold a cardholder 40 thereon. In FIG. 1, card holder 40 is shown as a horizontally arranged rectangle and FIG. 2 shows cardholder 40 as a vertically arranged rectangle.

Cardholder 40 has a substantially flat card receiving platform 49 and a plurality of card retention clips 50. It is noted that this configuration for cardholder 40 is only exemplary and that other card holder 40 designs may be used.

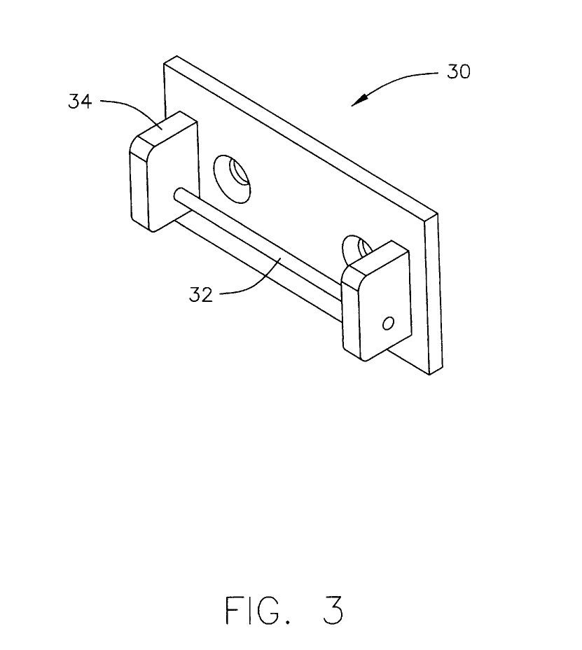

In FIGS. 1 and 2, mounting structure 30 (described in more detail below) is shown as a portion of cage 10. However, as shown in FIG. 3, in an alternative arrangement, mounting structure may be a separate component that is added to or attached (eg. by glue, epoxy, double side tape, ultrasonic welding, nails, screws, etc.) to the front face of cage 10. For the purposes of illustrating the salient features of mounting structure 30, it is shown and described as a portion of cage 10 as shown in FIGS. 1 and 2.

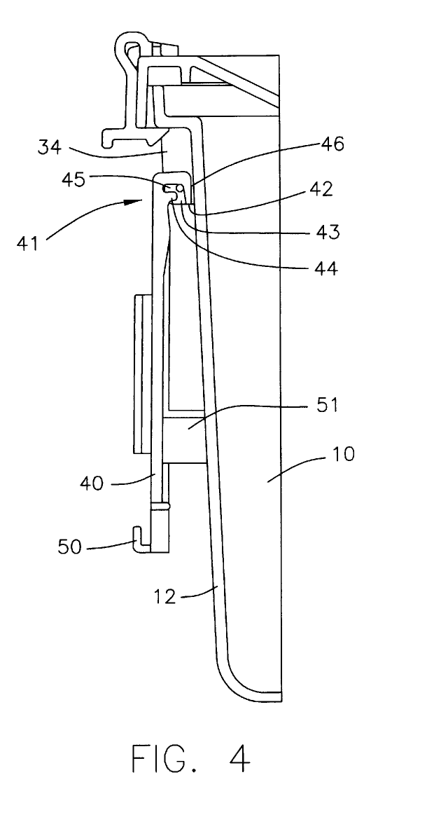

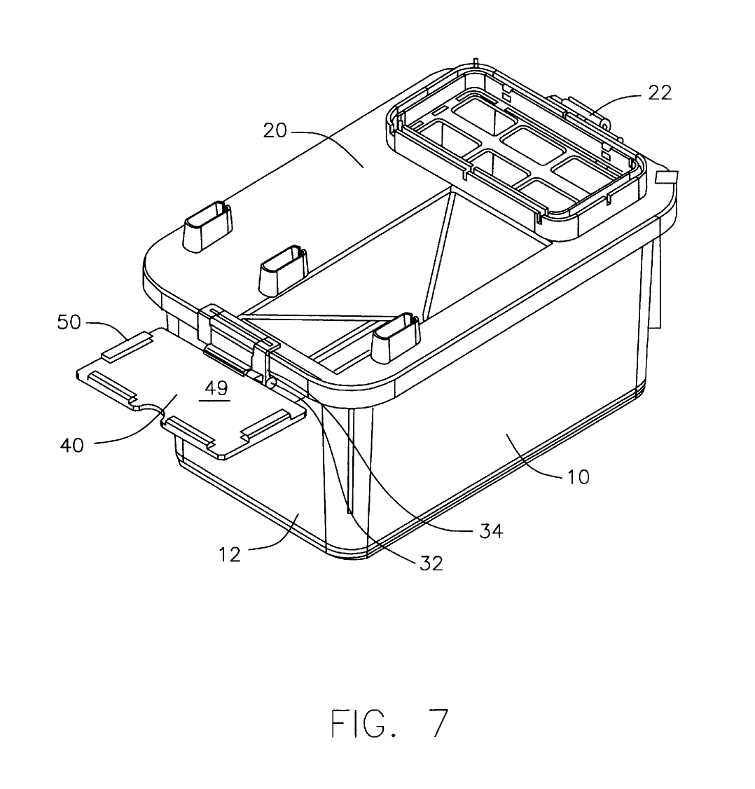

In one arrangement, as shown in FIG. 4, mounting structure 30 has a cross pin 32, held in place by two end mounts 34 (see also FIG. 7 for a perspective view) which are integrally molded into the side of the cage. Pin 32 is held in place within openings in end mounts 34, with the pin's 32 side to side movement being stopped and positioned by using locking clip, ring, head on one end pin, swaging, bending pin, or other such device.

In one arrangement, upper portion of cardholder 40 has a cam area 41 that includes a hook 42, such as a tapered hook, a pin clearance 43 and a lead 44, such as a curved lead, with a holding notch 45.

In one arrangement, the lower rear portion of card holder 40 has a positioning tab 51 so that when cardholder 40 is in the lowered position it rests substantially perpendicular (to the floor), partially extended away from the tapered side wall 12 of cage 10. Positioning tab 51 may be molded to different lengths and angles to match different cage 10 or other mounting surfaces' designs.

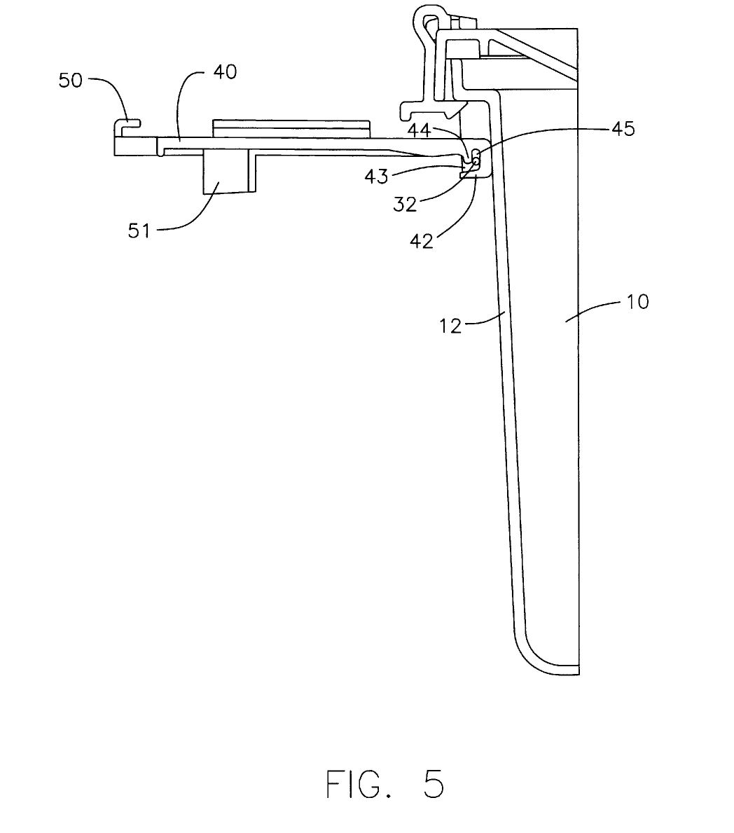

As shown in FIG. 5, when cardholder 40 is lifted to its upright position, a flat upper surface 46 of tapered hook 42 pushed downward in a curved fashion, allowing pin 32 to move through pin clearance 43. In this position, if force is removed from card holder 40, it would pivot back down to its original down position shown in FIG. 4.

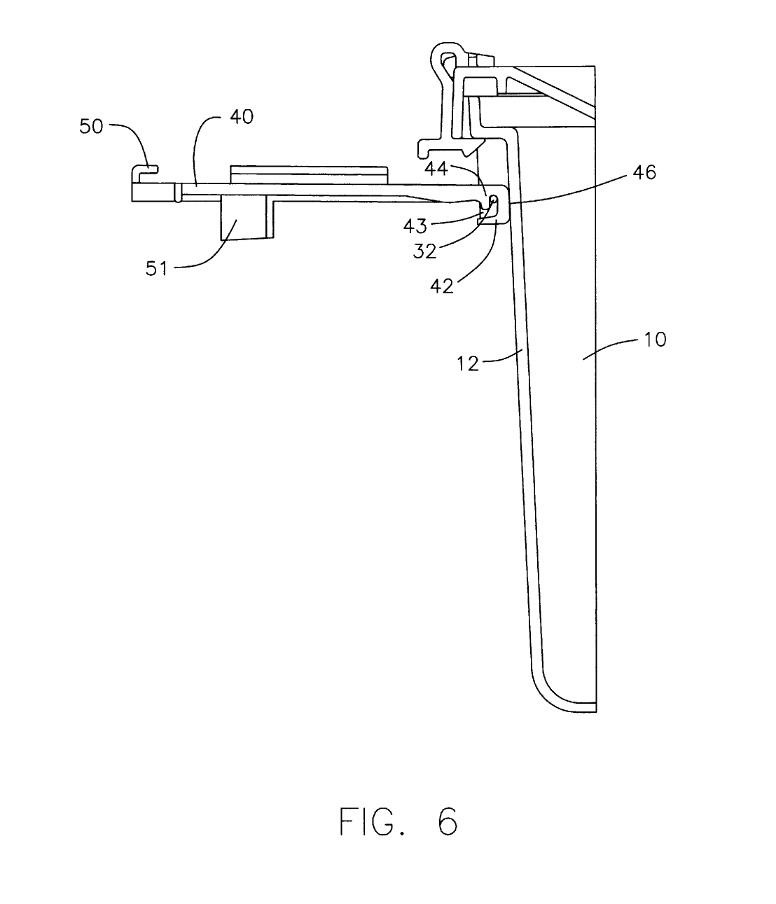

As shown in FIG. 6, after cardholder 40 is in the up position, pin 32 progresses relatively upward into pin clearance 43 behind curved lead 44. With flat upper surface 46 still placed against wall 12 of cage 10, cardholder 40 is now locked into the upright position. FIG. 7 shows a perspective view of cage 10 with card holder 40 in the upright position.

The wide space below the tight clearance in pin clearance 43 and the tapered and curved lead in tapered hook 42 and curved lead 44 and the tight clearance of upper surface 46 is designed that way to allow for easy positioning of cardholder 40 by a technician on and off pin 32 while at the same time making it hard for an accidental removal.

Pin clearance 43 and holding notch 45 are designed to a width that keeps cardholder 40 at that position unless some downward force is pushed on it. If there were force pushed on it, pin 32 slides up, deeper into notch 45. Without the downward force, cardholder 40 stays in this horizontal position, where pin 32 is just touching curved lead 44.

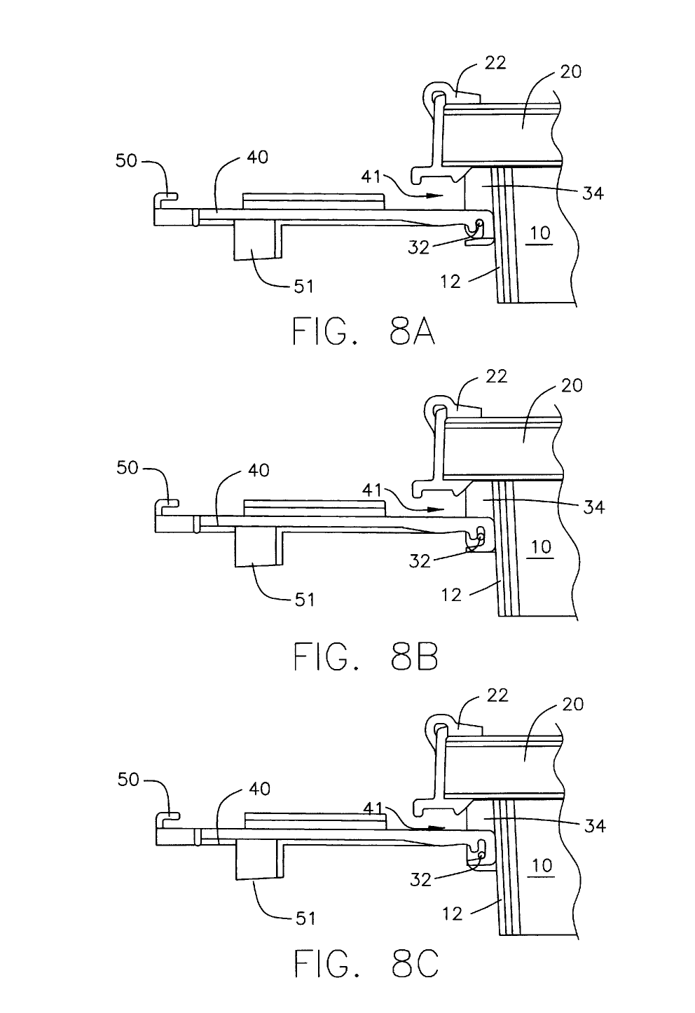

As shown in FIGS. 8A-8C, the lowering of locked-up card holder 40 is done by raising cardholder 40 upwards until pin 32 is lower within pin clearance 43 below curved lead 44. Then it may be bent downwards towards the front wall 12 of cage 10, allowing tapered hook to curve back up into its original resting position, as shown in FIGS. 1 and 4.

In normal use the random bouncing, shaking or juggling back and forth of cardholder 40 would not achieve the correct angle and positioning that is needed to remove the cardholder from pin 32.

In it is contemplated that cardholders 40 may be made in various colors, clear, translucent, opaque, etc. depending on the need. For example, clear cardholders used with clear index cards to let more light into the cages or to see inside better, red cardholders for danger/hazardous, yellow for caution, green-OK, different color for a different test or animal strands, etc.

While only certain features of the invention have been illustrated and described herein, many modifications, substitutions, changes or equivalents will now occur to those skilled in the art. It is therefore, to be understood that this application is intended to cover all such modifications and changes that fall within the true spirit of the invention.

What is claimed is:

1. A card holder, for use on an animal cage, said card holder comprising:
a card receiving area; and
a cam area for connecting said card holder to a pivot bar on said animal cage, wherein said cam area includes;
a hook;
a pin clearance;
a lead; and
a holding notch so that the card holder may be raised from a lower hanging position to an upward locked position.

2. The card holder as claimed in claim 1, wherein said hook is a tapered hook and wherein said lead is curved lead.

3. The card holder as claimed in claim 1, wherein said cam area further comprises a flat upper surface to be held against a front side wall of said cage.

4. The card holder as claimed in claim 3, wherein said pin clearance is to the inside of said hook, with said flat upper surface on the other side of said hook.

5. The card holder as claimed in claim 4, wherein said hook and said pin clearance are configured to engage said pivot bar of said cage.

6. The card holder as claimed in claim 5, wherein said pivot bar is latched against said lead of said cam area.

7. The card holder as claimed in claim 5, wherein said holding notch is configured to retain said pivot bar beyond said lead of said cam area to hold said card holder in an upwards position.

8. The card holder as claimed in claim 1, wherein said card holder further comprises a positioning tab so that when said card holder is in the lowered position it rests substantially perpendicular (to the floor), partially extended away from said tapered side wall of said cage.

9. The card holder as claimed in claim 1, wherein said pivot bar is removable from said animal cage.

10. The card holder as claimed in claim 1, wherein said pivot bar is supported on said cage by two end mounts for supporting said pivot bar, said end mounts being integrally formed portions of said cage.

11. The card holder as claimed in claim 1, wherein said pivot bar is supported on said cage by two end mounts for supporting said pivot bar, said end mounts being a portion of an attached component, attached to said cage.
